(19) United States
(12) Patent Application Publication
(10) Pub. No.: US 2013/0194894 A1
(43) Pub. Date: Aug. 1, 2013

(54) TRANSMISSION/RECEPTION CIRCUIT, ULTRASONIC PROBE, AND ULTRASONIC IMAGE DISPLAY APPARATUS

(71) Applicant: GE MEDICAL SYSTEM GLOBAL TECHNOLOGY COMPANY, LLC, Waukesha, WI (US)

(72) Inventor: Shinichi Amemiya, Tokyo (JP)

(73) Assignee: GE MEDICAL SYSTEMS GLOBAL TECHNOLOGY COMPANY, LLC, Waukesha, WI (US)

(21) Appl. No.: 13/752,837

(22) Filed: Jan. 29, 2013

(30) Foreign Application Priority Data
Jan. 30, 2012 (JP) 2012-016738

(51) Int. Cl. H04B 11/00

(52) U.S. Cl. CPC H04B 11/00
USPC 367/137

(57) ABSTRACT

A transmission/reception circuit for an ultrasonic probe having an ultrasonic transducer is provided. The transmission/reception circuit includes a first drive pulse generation unit configured to generate a first drive pulse for driving the ultrasonic transducer, a switch configured to turn on and off output of a second drive pulse for driving the ultrasonic transducer to the ultrasonic transducer, the second drive pulse supplied from an ultrasonic image display apparatus body connected to the ultrasonic probe, and a delay unit configured to add a delay time to an echo signal of an ultrasonic wave received by the ultrasonic transducer.

### CROSS REFERENCE TO RELATED APPLICATIONS

This application claims the benefit of Japanese Patent Application No. 2012-016738 filed Jan. 30, 2012, which is hereby incorporated by reference in its entirety.

### BACKGROUND OF THE INVENTION

The present invention relates to a transmission/reception circuit provided for an ultrasonic probe, an ultrasonic probe, and an ultrasonic image display apparatus.

A transmission/reception circuit in an ultrasonic image display apparatus has a drive pulse generation unit for generating a drive pulse which drives an ultrasonic transducer, and a delay unit for giving delay time to an echo signal of an ultrasonic wave received by the ultrasonic transducer. As described in, for example, Japanese Unexamined Patent Application Publication No. 2010-68957, such a transmission/reception circuit is provided in an ultrasonic image display apparatus body to which an ultrasonic probe is connected via a probe cable. Japanese Unexamined Patent Application Publication No. 2010-213771 discloses an ultrasonic probe provided with a transmission/reception circuit.

A plurality of drive pulse generation units is provided. Drive pulses of different phases are supplied from the plurality of drive pulse generation units to a plurality of ultrasonic transducers. Therefore, in the case where a transmission/reception circuit is provided in an ultrasonic image display apparatus body, the larger the number of ultrasonic transducers becomes, the larger the number of signal lines for supplying the drive pulse from the ultrasonic image display apparatus body to an ultrasonic probe becomes. Consequently, for example, the diameter of a probe cable of an ultrasonic probe having ultrasonic transducers of the number larger than that in a 1 D probe, such as a 1.5 D probe or a 1.75 D probe in which ultrasonic transducers are divided also in the elevation direction becomes larger than that of a probe cable for the 1 D probe.

It is considered to drive a plurality of ultrasonic transducers by a single drive pulse in order to suppress increase in the diameter of the probe cable even when the number of ultrasonic transducers increases. However, when the plurality of ultrasonic transducers are driven by drive pulses of the same phase and ultrasonic waves are transmitted, finer focus point control by drive pulse phase control cannot be performed.

In a B-mode image, the picture quality in a part close to the surface of the subject deteriorates. However, by forming the focus point of the ultrasonic beam in a part close to the surface of the subject, the picture quality in this part can be improved. For this purpose, however, finer focus control has to be performed by the drive pulse phase control.

On the other hand, in the case where the transmission/reception circuit is provided in the ultrasonic probe, drive pulses of different phases can be supplied from a plurality of drive pulse generation units in the transmission/reception circuit to a plurality of ultrasonic transducers. Consequently, without increase the diameter of the probe cable, the drive pulse phase control can be performed, and the picture quality of the B-mode image can be improved.

However, in the case where the transmission/reception circuit is provided in the ultrasonic probe, due to heat generated by electric energy for generating the drive pulse, the surface temperature of the ultrasonic probe rises. Since the surface temperature of the ultrasonic probe is limited, in the case where a transmission/reception circuit is provided in the ultrasonic probe, in some cases, transmission has to be performed with lower power so that the surface temperature does not exceed the limit of the surface temperature. Such a temperature rise problem does not occur when a transmission/reception circuit is provided in the ultrasonic image display apparatus body.

From the above, in the case where the transmission/reception circuit is provided in the ultrasonic probe, the picture quality of a B-mode image can be improved without increasing the diameter of the probe cable. On the other hand, in the case where the transmission/reception circuit is provided in an ultrasonic diagnostic apparatus body, rise in the surface temperature of the ultrasonic probe can be prevented. Therefore, it is desired to satisfy both the advantage in the case where the transmission/reception circuit is provided on the ultrasonic image display apparatus body side and the advantage in the case where the transmission/reception circuit is provided on the ultrasonic probe side.

### BRIEF DESCRIPTION OF THE INVENTION

In one aspect, a transmission/reception circuit is provided for an ultrasonic probe having an ultrasonic transducer. The transmission/reception circuit includes a first drive pulse generation unit for generating a first drive pulse which drives the ultrasonic transducer, a switch for turning on/off output to the ultrasonic transducer, of a second drive pulse supplied from an ultrasonic image display apparatus body to which the ultrasonic probe is connected and driving the ultrasonic transducer, and a delay unit for giving delay time to an echo signal of an ultrasonic wave received by the ultrasonic transducer.

According to the above-described aspect, either the first drive pulse generated by the first drive pulse generation unit in the transmission/reception circuit provided for the ultrasonic probe or the second drive pulse supplied from the ultrasonic image display apparatus body can be supplied to the ultrasonic transducer. Therefore, both the advantage in the case where the transmission/reception circuit is provided on the ultrasonic image display apparatus body side and the advantage in the case where the transmission/reception circuit is provided on the ultrasonic probe side can be obtained.

### BRIEF DESCRIPTION OF THE DRAWINGS

FIG. 1 is a block diagram illustrating an example of an embodiment of an ultrasonic image display apparatus.

FIG. 2 is a block diagram illustrating an internal configuration of an ultrasonic probe in the ultrasonic image display apparatus depicted in FIG. 1.

FIG. 3 is a block diagram illustrating the configuration of a unit in the transmission/reception circuit depicted in FIG. 2.

FIG. 4 is a diagram illustrating the configuration of a delay unit in the unit depicted in FIG. 3.

FIG. 5 is a diagram for explaining on/off timings of write switches and read switches in the delay unit depicted in FIG. 4.

FIG. 6 is a block diagram illustrating a transmission/reception unit in the ultrasonic image display apparatus depicted in FIG. 1.

FIG. 7 is a block diagram illustrating the configuration of a transmission unit in the transmission/reception unit depicted in FIG. 6.

FIG. 8 is an explanatory diagram illustrating an ultrasonic beam formed by an acoustic lens and an ultrasonic beam formed by drive pulse phase control.

FIG. 9 is a block diagram illustrating that switches are in the on state in the unit depicted in FIG. 3.

FIG. 10 is a block diagram illustrating the configuration of a unit in a transmission/reception circuit in a second embodiment.

FIG. 11 is a block diagram illustrating that the switches are in the on state in the unit depicted in FIG. 10.

### DETAILED DESCRIPTION OF THE INVENTION

Hereinafter, exemplary embodiments will be described in detail with reference to the drawings.

### First Embodiment

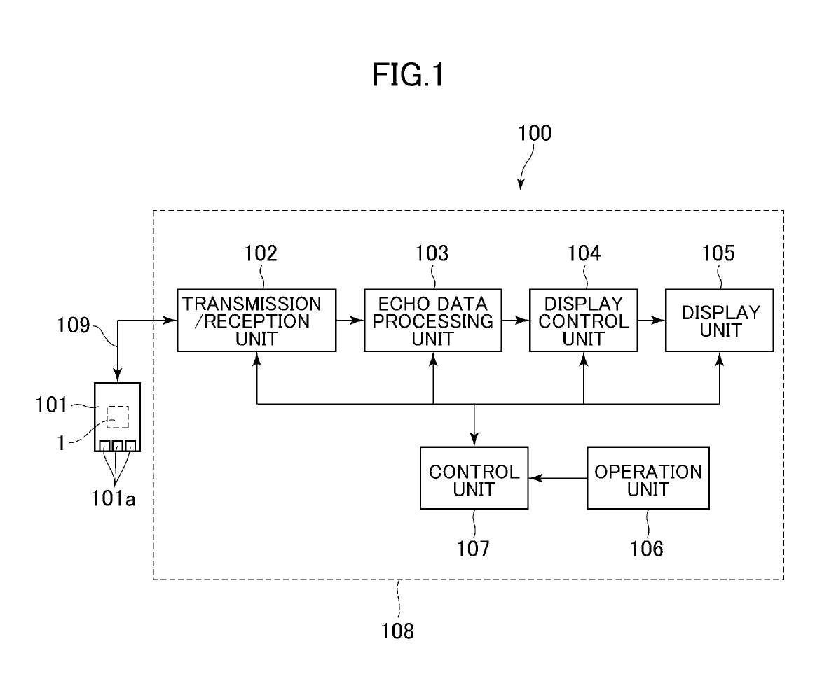

A first embodiment will be described with reference to FIGS. 1 to 9. As illustrated in FIG. 1, an ultrasonic image display apparatus 100 is, for example, an ultrasonic diagnosis apparatus which transmits/receives ultrasonic waves to/from a patient and displays an ultrasonic image such as a B-mode image. The ultrasonic image display apparatus 100 has an ultrasonic probe 101, a transmission/reception unit 102, an echo data processing unit 103, a display control unit 104, a display unit 105, an operation unit 106, and a control unit 107. The ultrasonic probe 101 is connected to an ultrasonic image display apparatus body 108 via a probe cable 109.

The ultrasonic diagnostic image display apparatus body 108 has the transmission/reception unit 102, the echo data processing unit 103, the display control unit 104, the display unit 105, the operation unit 106, and the control unit 107.

The echo data processing unit 103 performs a process for generating an ultrasonic image on echo data received from the transmission/reception unit 102. For example, the echo data processing unit 103 performs a B-mode process such as a logarithmic compression process or an envelope detection process, a Doppler process such as a quadrature detection process or a filter process, and the like.

The display control unit 104 scan-converts data obtained by the echo data processing unit 103 by a scan converter to generate ultrasonic image data. The display control unit 104 makes the display unit 105 display an ultrasonic image based on the ultrasonic image data. The ultrasonic image is, for example, a B-mode image or a color Doppler image.

The display unit 105 is an LCD (Liquid Crystal Display), a CRT (Cathode Ray Tube), or the like. The operation unit 106 includes a keyboard, a pointing device (not illustrated), and the like for the operator to enter an instruction and information.

The control unit 107 has a CPU (Central Processing Unit). The control unit 107 reads a control program stored in a not-illustrated storage and makes a function in each of the units of the ultrasonic image display apparatus 100 executed.

Next, the ultrasonic probe 101 and the transmission/reception unit 102 will be described. The ultrasonic probe 101 is provided with a plurality of ultrasonic transducers 101a for transmitting/receiving ultrasonic waves. The operator makes the ultrasonic probe 101 comes into contact with the surface of the subject to transmit/receive ultrasonic waves.

The ultrasonic probe 101 may be, for example, a 1.75 D probe or a 1 D probe.

The ultrasonic probe 101 has a transmission/reception circuit 1. The transmission/reception circuit 1 is an example of a mode of carrying out the transmission/reception circuit.

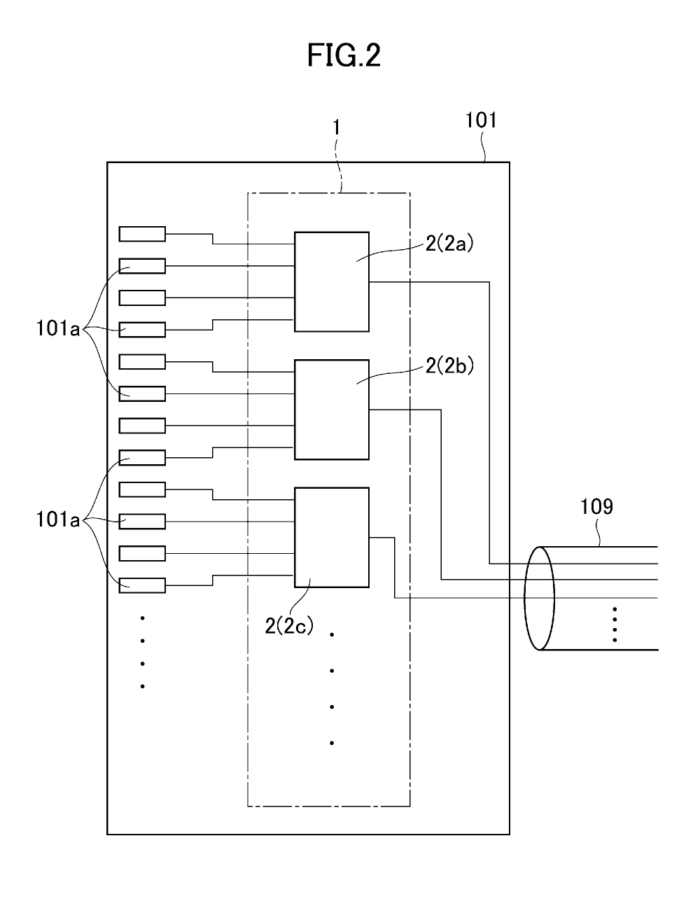

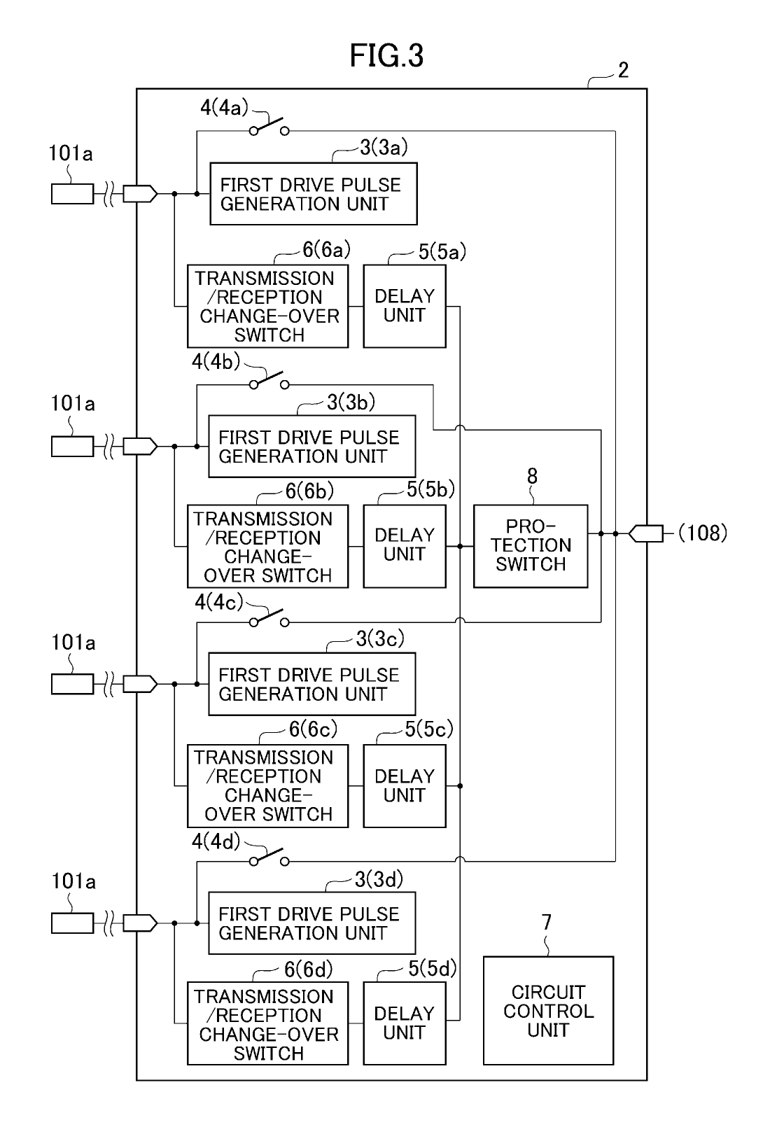

As illustrated in FIG. 2, the transmission/reception circuit 1 has a plurality of units 2 (2a, 2b, 2c, . . . ). As illustrated in FIG. 3, the unit 2 has a first drive pulse generation unit 3, a switch 4, and a delay unit 5. The unit 2 also has a transmission/reception change-over switch 6, a circuit control unit 7, and a protection switch 8.

The first drive pulse generation unit 3, the switch 4, the delay unit 5, and the transmission/reception change-over switch 6 are provided so as to be paired with the ultrasonic transducer 101a. One unit 2 includes four sets of the first drive pulse generation units 3a to 3d, the switches 4a to 4d, the delay units 5a to 5d, and the transmission/reception change-over switch 6a to 6d.

The first drive pulse generation unit 3 generates a first drive pulse for driving the ultrasonic transducer 101a. The first drive pulse generation unit 3 is an example of an embodiment of a first drive pulse generation unit.

The first drive pulse generation units 3a to 3d generate first drive pulses each having a predetermined phase. Therefore, the first drive pulses having different phases can be supplied to the ultrasonic transducers 101a, and finer focus point control can be performed by phase control.

The switch 4 is provided in parallel with the first drive pulse generation unit 3. The switch 4 turns on/off output to the ultrasonic transducer 101a, of a second drive pulse which is supplied from the ultrasonic image display apparatus body 108 and drives the ultrasonic transducer 101a. The switch 4 is an example of an embodiment of the switch in.

The switches 4a to 4d are provided in parallel to one another. A common second drive pulse is supplied from the ultrasonic image display apparatus body 108 to one unit 2. Consequently, the number of signal lines in the probe cable 109 is decreased, and increase in the diameter of the probe cable 109 can be prevented. Second drive pulses of the same phase are supplied to the ultrasonic transducers 101a.

On the other hand, the phases of the second drive pulses supplied to the plurality of units 2 may be different.

The transmission/reception change-over switch 6 is connected between the first drive pulse generation unit 3 and the switch 4 and the ultrasonic transducer 101a. The delay unit 5 is connected to the transmission/reception change-over switch 6 in series. By the transmission/reception change-over switch 6, transmission and reception of ultrasonic waves are switched.

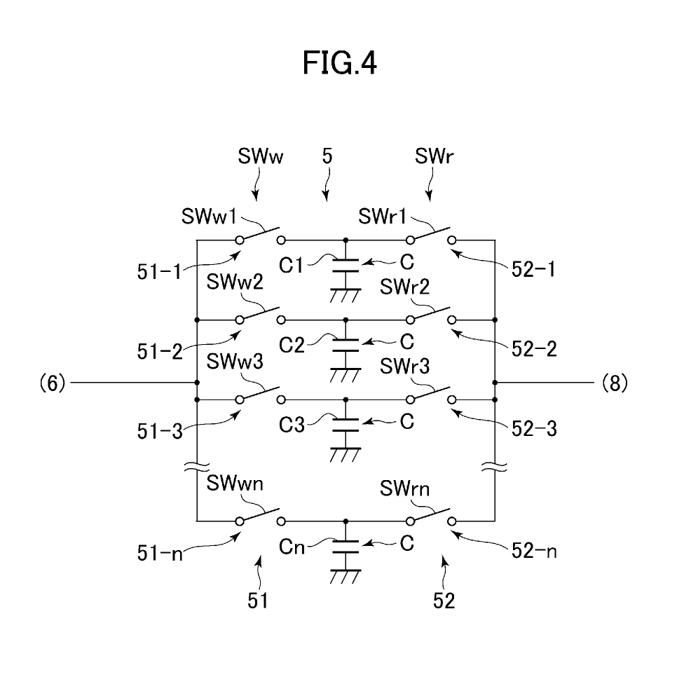

The delay unit 5 gives delay time to an echo signal of the ultrasonic wave received by the ultrasonic transducer 101a. An example of the configuration of the delay unit 5 will be described with reference to FIG. 4. The delay unit 5 is the same as that described in U.S. patent application No. 13/016783 and has a capacitor C, a write switch SWw, and a read switch SWr. At an anterior stage of the delay unit 5, the echo signal of the ultrasonic wave may be amplified.

A plurality of capacitors C, a plurality of write switches SWw, and a plurality of read switches SWr are provided. Specifically, capacitors C1, C2, C3, . . . , and Cn (n denotes natural number), write switches SWw1, SWw2, SWw3, . . . , and SWwn, and read switches SWr1, SWr2, SWr3, . . . , and SWrn are provided. The capacitor C, the write switch SWw, and the read switch SWr are connected to one another in parallel. By such a parallel circuit, current sampling is performed.

One end side of the write switch SWw is connected to the transmission/reception change-over switch 6, and the other end side is connected to one end side of the capacitor C. The other end side of the capacitor C is connected to the ground. Further, one end side of the read switch SWr is connected to one end side of the capacitor, and the other end side is connected to the protection switch 8 side.

By the write switch SWw, the capacitor C, and the ground, a write circuit 51 for writing current converted from the ultrasonic wave echo to the capacitor C in the ultrasonic transducer 101a is constructed. In the write circuit 51, a plurality of write circuits 51-1, 51-2, 51-3, . . . , and 51-n are provided in parallel. In each of the write circuits 51, when the write switch SWw is in the on state, current from the ultrasonic transducer 101a is written (charged) to the capacitor C.

By the read switch SWr, the capacitor C, and the ground, a read circuit 52 for reading the current written in the capacitor C is constructed. In the read circuit 52, a plurality of read circuits 52-1, 52-2, 52-3, . . . , and 52-n are provided in parallel. In each of the read circuits 52, when the read switch SWr is in the on state, the current written in the capacitor C is read.

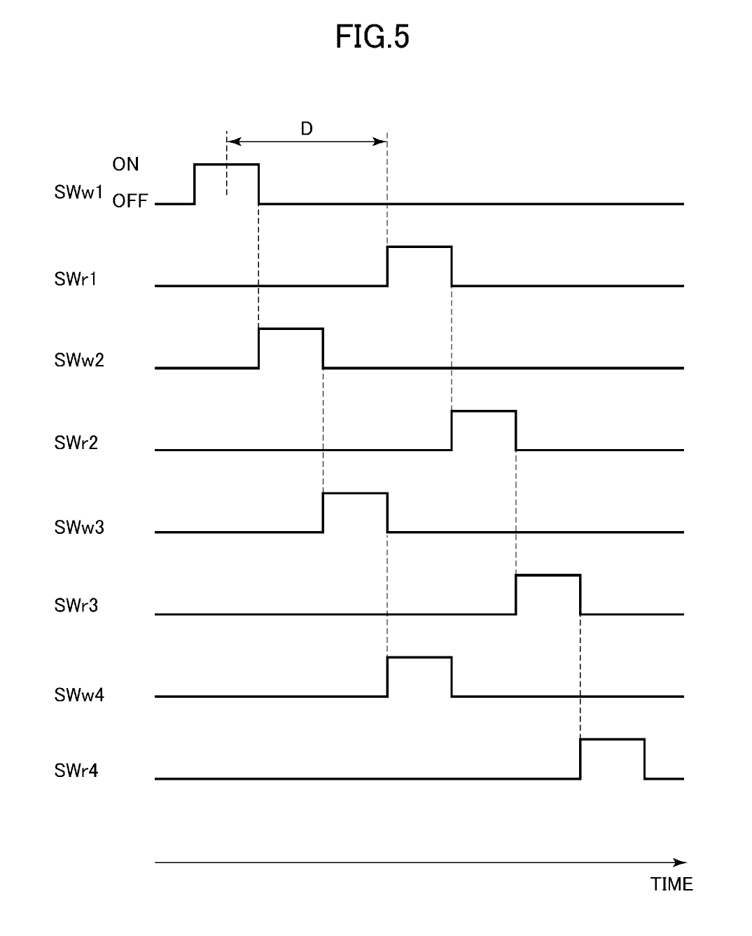

Timings of turning on/off the write switch SWw and the read switch SWr will be described. As illustrated in FIG. 5, when any one of the write switches SWw is turned on, the others are in the off state.

Similarly, when any one of the read switches SWr is turned on, the others are in the off state.

The write switches SWw and the read switches SWr are turned on in turns. Specifically, a write switch SWwm (m denotes natural number of 2 to n) is turned on when an adjacent write switch SWw(m−1) changes from the on state to the off state. For example, when the write switch SWw1 changes from the on state to the off state, the write switch SWw2 changes from the off state to the on state. When the write switch SWw2 changes from the on state to the off state, the write switch SWw3 enters the on state. As a result, the current from the ultrasonic transducer 101a is written in the capacitors C in order. Similarly, the read switch SWrm (m denotes natural number of 2 to n) is turned on when the adjacent read switch SWr(m−1) changes from the on state to the off state.

The time in the on state of the write switches SWw1 to SWwn is the same. The time in the on state of the read switches SWr1 to SWrn is also the same.

A circuit for discharging the current in the capacitor C remained after the current in the capacitor C is read by the read switch SWr may be provided.

As illustrated in FIG. 5, the delay time D given by the delay unit 5 is time since the midpoint of the period of writing (charging) current to the capacitor C (the period in which the write switch SWw is in the on state) to the moment when the read switch SWr changes from the off state to the on state.

The currents output from the delay units 5a to 5d are added in the anterior stage of the protection switch 8 connected to the delay units 5a to 5d in series (refer to FIG. 3). At the time of receiving an ultrasonic wave, the protection switch 8 turns on, and the currents added at the anterior stage of the protection switch 8 is supplied to the transmission/reception unit 102 in the ultrasonic image display apparatus body 108 via the probe cable 109.

The circuit control unit 7 controls the first drive pulse generation unit 3, the switch 4, the transmission/reception change-over switch 6, the protection switch 8, the write switch SWw and the read switch SWr. The control circuit unit 7 receives a control signal from the control unit 107 of the ultrasonic image display apparatus body 108 and performs the control. The circuit control unit 7 is an example of an embodiment of the circuit control unit.

Specifically, when an ultrasonic wave is transmitted, the circuit control unit 7 controls the first drive pulse generation unit 3 and the switch 4 so that either the first drive pulse or the second drive pulse is supplied to the ultrasonic transducer 101a. At the time of transmitting an ultrasonic wave, the circuit control unit 7 sets the transmission/reception change-over switch 6 and the protection switch 8 into the off state. On the other hand, at the time of receiving an ultrasonic wave, the circuit control unit 7 sets the switch 4 into the off state, and sets the transmission/reception change-over switch 6 and the protection switch 8 into the on state.

As described above, the circuit control unit 7 controls the on/off state of the write switches SWw and the read switches SWr.

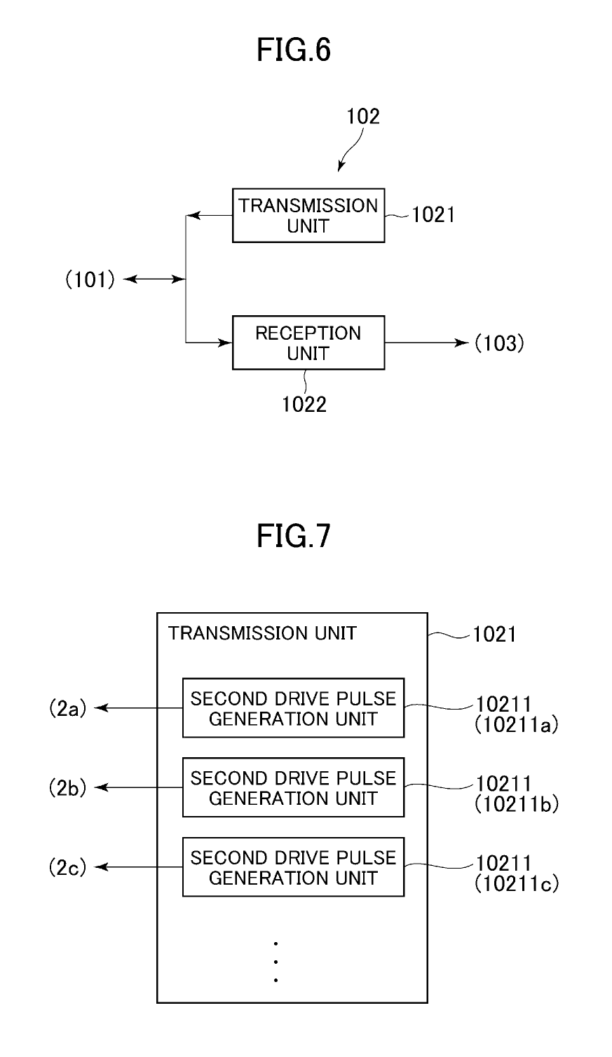

Next, the transmission/reception unit 102 will be described with reference to FIG. 6. The transmission/reception unit 102 has a transmission unit 1021 and a reception unit 1022. The transmission unit 1021 and the reception unit 1022 are constructed using known circuits.

As illustrated in FIG. 7, the transmission unit 1021 has a second drive pulse generation unit 10211. The second drive pulse generation unit 10211 generates the second drive pulse. The second drive pulse generation unit 10211 generates the second drive pulse on the basis of a control signal from the control unit 107. The second drive pulse generation unit 10211 is an example of an embodiment of the second drive pulse generation unit.

The transmission unit 1021 is provided with, as the second drive pulse generation units 10211, a plurality of second drive pulse generation units 10211a, 10211b, 10211c, . . . The second drive pulse generation units 10211a, 10211b, 10211c, . . . generate second drive pulses of different phases.

The second drive pulses generated by the second drive pulse generation unit 1021 are supplied to the unit 2. For example, the second drive pulse generated by the second drive pulse generation unit 10211a is supplied to the unit 2a (refer to FIG. 2). The second drive pulse generated by the second drive pulse generation unit 10211b is supplied to the unit 2b. The second drive pulse generated by the second drive pulse generation unit 10211c is supplied to the unit 2c.

The reception unit 1022 delays and adds echo signals (currents) output from the plurality of units 2a, 2b, 2c, . . . The reception unit 1022 outputs the echo signal delayed and added to the echo data processing unit 103. The reception unit 1022 is an example of an embodiment of the delay and addition unit.

The operation of the ultrasonic image display apparatus 100 of the embodiment will now be described. For example, in the case where ultrasonic waves for generating a B-mode image are transmitted/received, when the finer focus point control is performed by the control of phases of the drive pulses, the first drive pulse generation unit 3 generates a first drive pulse, and the first drive pulse is supplied to the ultrasonic transducer 101a.

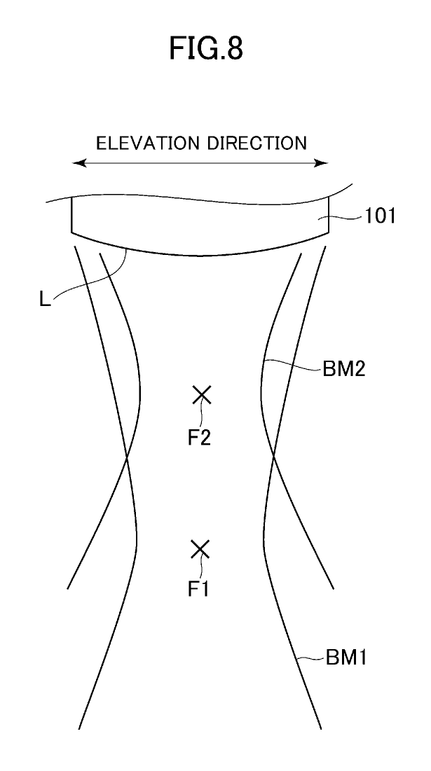

As illustrated in FIG. 8, in the case of transmitting an ultrasonic beam BM2 having a focus point F2 on the surface side of the subject with which the ultrasonic probe 101 comes into contact, not a focus point F1 of an ultrasonic beam BM1 formed by an acoustic lens L of the ultrasonic probe 101, the exemplary embodiment, the first drive pulse is supplied to the ultrasonic transducer 101a. The reason will be described. The picture quality in a part close to the surface of the subject in a B-mode image deteriorates. However, by forming the focus point of the ultrasonic beam in a part close to the surface of the subject, the picture quality can be improved. The closer the focus point of the ultrasonic beam to the surface of the subject is, the lower the transmission voltage is. Therefore, even when the first drive pulse generation unit 3 generates the first drive pulse and the ultrasonic beam MB2 having the focus point F2 is transmitted, rise in the surface temperature of the ultrasonic probe 101 can be suppressed. Consequently, by shifting the focus from the focus point F1 to the focus point F2 formed by the acoustic lens L while suppressing rise in the surface temperature of the ultrasonic probe 101, the picture quality can be improved.

In the case where the first drive pulse is supplied to the ultrasonic transducer 101a, the switch 4 is in the off state (refer to FIG. 3).

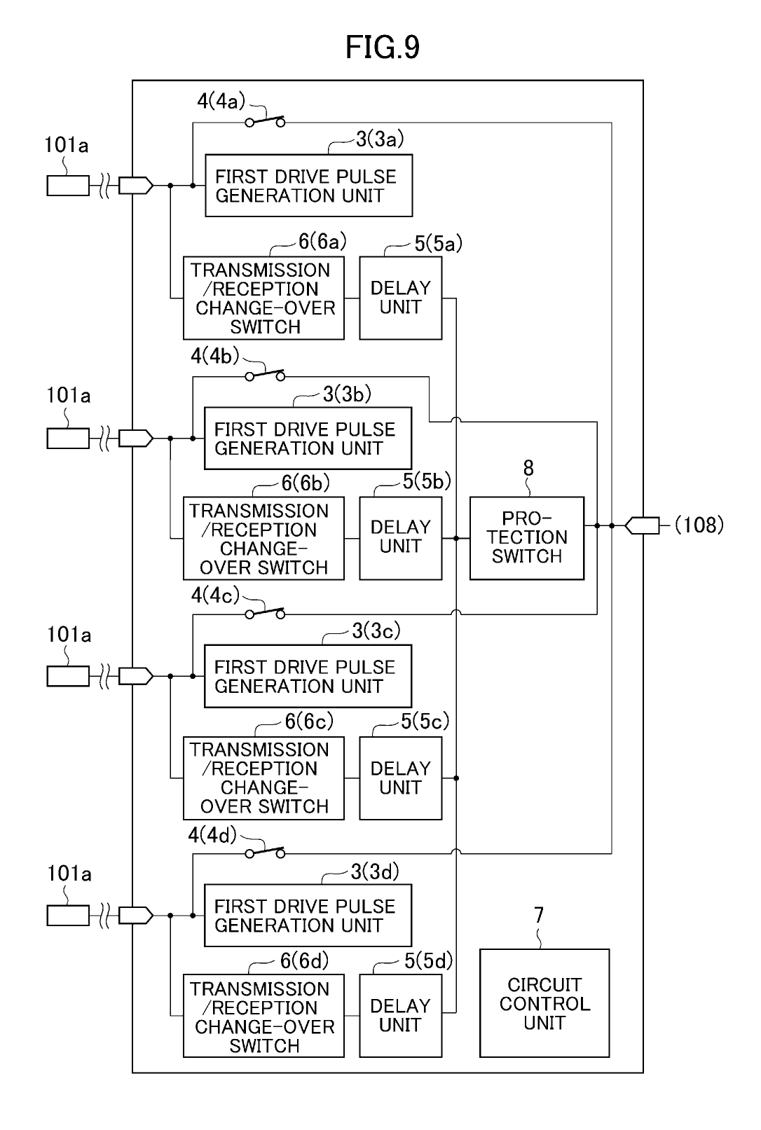

On the other hand, in the case of generating a Doppler image, it is unnecessary to perform the finer focus point control by the control of phases of the drive pulses. Since the ultrasonic wave transmitted to generate a Doppler image is a relatively long burst wave, a power loss is large and larger amount of heat is generated. Therefore, in the case where an ultrasonic wave for generating a Doppler image is transmitted/received, as illustrated in FIG. 9, the switch 4 enters the on state, and the second drive pulse generated by the second drive pulse generation unit 10211 is supplied to the ultrasonic transducer 101a.

In the case where the surface temperature of the ultrasonic probe 101 does not exceed the limitation by transmission of the ultrasonic wave, any of the first and second drive pulse may be supplied to the ultrasonic transducer 101a. In the case where the surface temperature of the ultrasonic probe 101 does not exceed the limit and the drive pulse phase control is necessary, it is desirable to supply the first drive pulse.

On the other hand, when there is the possibility that the surface temperature of the ultrasonic probe 101 exceeds the limit, the second drive pulse is supplied. When there is the possibility that the surface temperature of the ultrasonic probe 101 exceeds the limit and the drive pulse phase control is unnecessary, it is desirable to supply the second drive pulse.

According to the embodiment, both the advantage in the case where the transmission/reception circuit is provided in the ultrasonic image display apparatus body side and the advantage in the case where the transmission/reception circuit is provided in the ultrasonic probe side can be obtained.

### Second Embodiment

A second embodiment will be described. Description of the same matters as those of the first embodiment will not be repeated.

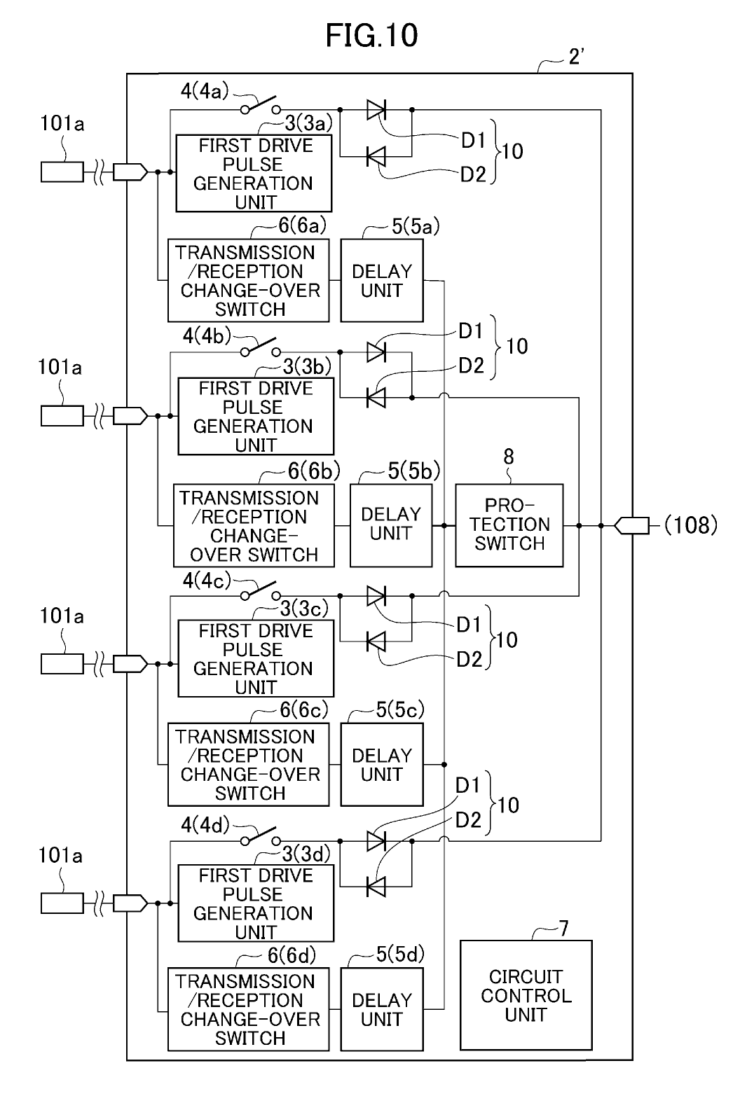

As illustrated in FIG. 10, a unit 2′ of the transmission/reception circuit 1 of the embodiment has a bidirectional diode 10 made of diodes D1 and D2. The bidirectional diode 10 is connected to the switch 4 in series. The bidirectional diode 10 is provided closer to the ultrasonic image display apparatus body 108 side than the switch 4 (the side opposite to the ultrasonic transducer 101a).

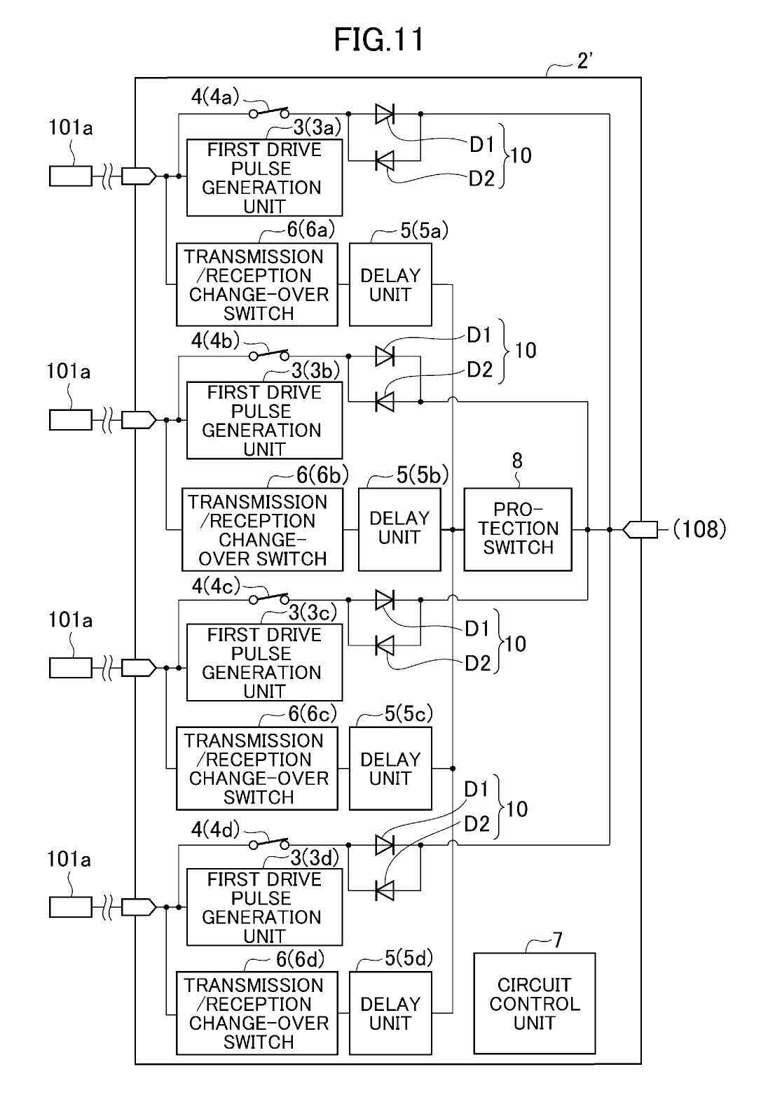

Also in the embodiment, the same effect as that of the first embodiment can be obtained. In addition, by providing the bidirectional diode 10, as illustrated in FIG. 11, it is unnecessary to set the switch 4 into the off set at the time of receiving the ultrasonic wave. Therefore, in the case of supplying the second drive pulse, occurrence of noise due to switching of the switch 4 can be prevented.

Although exemplary embodiments have been described herein, the various modifications can be made without departing from the spirit and scope of the invention. For example, the configuration of each of the transmission/reception circuit 1 and the unit 2 is an example and can be changed without departing from the gist of the invention. The configuration of the delay unit 12 is also an example and can be changed.

1. A transmission/reception circuit for an ultrasonic probe having an ultrasonic transducer, the transmission/reception circuit comprising:
a first drive pulse generation unit configured to generate a first drive pulse for driving the ultrasonic transducer;
a switch configured to turn on and off output of a second drive pulse for driving the ultrasonic transducer to the ultrasonic transducer, the second drive pulse supplied from an ultrasonic image display apparatus body connected to the ultrasonic probe; and
a delay unit configured to add a delay time to an echo signal of an ultrasonic wave received by the ultrasonic transducer.

2. The transmission/reception circuit according to claim 1, wherein the first drive pulse generation unit and the switch are configured to be controlled such that either the first drive pulse or the second drive pulse is supplied to the ultrasonic transducer.

3. The transmission/reception circuit according to claim 1, further comprising a circuit control unit configured to control the first drive pulse generation unit and the switch.

4. The transmission/reception circuit according to claim 1, wherein the first drive pulse generation unit, the switch, and the delay unit are paired with the ultrasonic transducer.

5. The transmission/reception circuit according to claim 4, wherein a plurality of sets each including the first drive pulse generation unit, the switch, and the delay unit are provided.

6. The transmission/reception circuit according to claim 1, wherein the plurality of first drive pulse generation units are configured to generate first drive pulses having different phases.

7. The transmission/reception circuit according to claim 1, further comprising a plurality of units each including the first drive pulse generation unit, the switch, and the delay unit.

8. The transmission/reception circuit according to claim 7, wherein each unit has a plurality of first drive pulse generation units, a plurality of switches, and a plurality of delay units.

9. The transmission/reception circuit according to claim 8, wherein output signals of the plurality of delay units are configured to be added in each unit.

10. The transmission/reception circuit according to claim 7, wherein a plurality of second drive pulses of different phases are configured to be supplied to the plurality of units.

11. The transmission/reception circuit according to claim 1, further comprising a bidirectional diode connected to the switch in series such that the bidirectional diode is closer than the switch to an ultrasonic image display apparatus body.

12. An ultrasonic probe comprising:
an ultrasonic transducer; and
a transmission/reception circuit comprising:
a first drive pulse generation unit configured to generate a first drive pulse for driving the ultrasonic transducer;
a switch configured to turn on and off output of a second drive pulse for driving the ultrasonic transducer to the ultrasonic transducer, the second drive pulse supplied from an ultrasonic image display apparatus body connected to the ultrasonic probe; and
a delay unit configured to add a delay time to an echo signal of an ultrasonic wave received by the ultrasonic transducer.

13. An ultrasonic image display apparatus comprising:
an ultrasonic probe comprising:
an ultrasonic transducer; and
a transmission/reception circuit comprising:
a first drive pulse generation unit configured to generate a first drive pulse for driving the ultrasonic transducer,
a switch configured to turn on and off output of a second drive pulse for driving the ultrasonic transducer to the ultrasonic transducer, the second drive pulse supplied from an ultrasonic image display apparatus body connected to the ultrasonic probe; and
a delay unit configured to add a delay time to an echo signal of an ultrasonic wave received by the ultrasonic transducer; and
an ultrasonic image display apparatus body connected to the ultrasonic probe.

14. The ultrasonic image display apparatus according to claim 13, wherein the ultrasonic image display apparatus body comprises a second drive pulse generation unit configured to generate the second drive pulse.

15. The ultrasonic image display apparatus according to claim 14, further comprising a plurality of second drive pulse generation units.

16. The ultrasonic image display apparatus according to claim 15, wherein the plurality of second drive pulse generation units are configured to generate second drive pulses having different phases.

17. The ultrasonic image display apparatus according to claim 13, wherein the ultrasonic image display apparatus body comprises a delay and addition unit configured to delay and add a plurality of echo signals output from the ultrasonic probe.

18. The ultrasonic image display apparatus according to claim 14, wherein the ultrasonic image display apparatus body comprises a delay and addition unit configured to delay and add a plurality of echo signals output from the ultrasonic probe.

19. The ultrasonic image display apparatus according to claim 15, wherein the ultrasonic image display apparatus body comprises a delay and addition unit configured to delay and add a plurality of echo signals output from the ultrasonic probe.

20. The ultrasonic image display apparatus according to claim 16, wherein the ultrasonic image display apparatus body comprises a delay and addition unit configured to delay and add a plurality of echo signals output from the ultrasonic probe.
